(19) United States
(12) Patent Application Publication
(10) Pub. No.: US 2011/0036064 A1
(43) Pub. Date: Feb. 17, 2011

(54) HARVESTING APPARATUS AND METHOD INCORPORATING COOLING ZONE

(76) Inventors: Frank Maconachy, Salinas, CA (US); Jim Ivelich, Watsonville, CA (US)

Correspondence Address: WEISS & MOY PC, 4204 NORTH BROWN AVENUE, SCOTTSDALE, AZ, 85251, US

(21) Appl. No.: 12/571,475

(22) Filed: Oct. 1, 2009

Related U.S. Application Data
(60) Provisional application No. 61/234,036, filed on Aug. 14, 2009.

(51) Int. Cl. A01D 34/00; B60H 1/32; F25D 9/00; F25D 23/00; F25D 25/00

(52) U.S. Cl. 56/10.1; 62/239; 62/401; 62/259.1; 62/62

(57) ABSTRACT

A mobile cooling apparatus and method for harvested produce includes working platform and a cooling zone. Produce harvested along the working platform and transferred thereto is placed into the cooling zone which, in one embodiment, is located on an opposite side of the working platform from where harvesting is occurring. The cooling zone may be open at an outward facing end thereof, to permit offloading of harvested produce to a second mobile apparatus. The cooling zone may be dimensioned to contain at least one pallet and, in one embodiment, two pallets positioned side-by-side.

### CROSS-REFERENCE TO RELATED APPLICATION

Priority under 35 U.S.C. §119 is claimed based on U.S. Provisional Application No. 61/234,036, filed on Aug. 14, 2009, the disclosure of which is expressly incorporated herein by reference.

### FIELD OF THE INVENTION

This invention relates generally to harvesting apparatuses and methods and, more particularly, to a harvesting apparatus and method utilizing a mobile cooling zone.

### BACKGROUND OF THE INVENTION

Certain types of produce, including for example berries, absorb field heat. A relatively significant period of time can pass between the harvesting of such produce, and its placement into a refrigerated environment, where the field heat is finally removed. According to industry practice, strawberries, for example, are cooled, remote from the field, to a temperature of 35 degrees F. prior to wholesale distribution. The hotter the temperature of the harvested produce, the longer it will take to cool it to the desired temperature. During the period between harvesting and refrigeration at a remote site, the presence of un-removed field heat can reduce the ultimate shelf-life of the harvested produce. In addition, the warmer the produce when reaching the remote refrigeration site, the greater the amount of energy needed to achieve the desired cooling.

The present invention is directed to an apparatus and method that permits the rapid and mobile removal of field heat closely following harvesting, on a mobile apparatus that travels through the field and proximate the location of harvesting activities. The goal of such removal is to increase shelf life and reduce energy costs. The present invention also provides other benefits and advantages, as herein described.

### BRIEF DESCRIPTION OF THE INVENTION

In accordance with an embodiment of the present invention, a mobile cooling apparatus for harvested produce is disclosed. The apparatus comprises, in combination: a working platform; a cooling zone accessible from the working platform and positioned to receive therein produce picked by pickers working in a field along the apparatus; and a drive assembly adapted to propel the working platform and cooling zone through a field.

In accordance with another embodiment of the present invention, a mobile cooling, apparatus for harvested produce is disclosed. The apparatus comprises, in combination: a working platform; a cooling zone removably coupled to the working platform and positioned to receive therein produce picked by pickers working in a field along the apparatus; and a drive assembly adapted to propel the working platform and cooling zone through a field; wherein the working platform has a first side accessible to the pickers working in the field along the apparatus and a second side opposite thereto and wherein the cooling zone is located proximate the second side; and wherein the cooling zone is open at an end facing outward from the apparatus, and wherein such opening is dimensioned to permit off-loading of harvested produce from an interior of the cooling zone to another mobile apparatus.

In accordance with a further embodiment of the present invention, a method for mobile cooling of harvested produce comprising: providing a mobile cooling apparatus comprising, in combination: a working platform; a cooling zone accessible from the working platform and positioned to receive therein produce picked by pickers working in a field along the apparatus; and a drive assembly adapted to propel the working platform and cooling zone through a field; receiving newly-harvested produce on the working platform; and placing the newly-harvested produce into the cooling zone.

### BRIEF DESCRIPTION OF THE DRAWINGS

FIG. 1 is a top view of a harvesting apparatus consistent with an embodiment of the present invention, in a transport and shift configuration.

FIG. 2 is a top view of a harvesting apparatus consistent with an embodiment of the present invention, in use for harvesting.

FIG. 3 is a front view of the harvesting apparatus of FIG. 2.

FIG. 4 is a side view of the harvesting apparatus of FIG. 2.

FIG. 5 is a front view of the harvesting apparatus of FIG. 2 in a transport configuration.

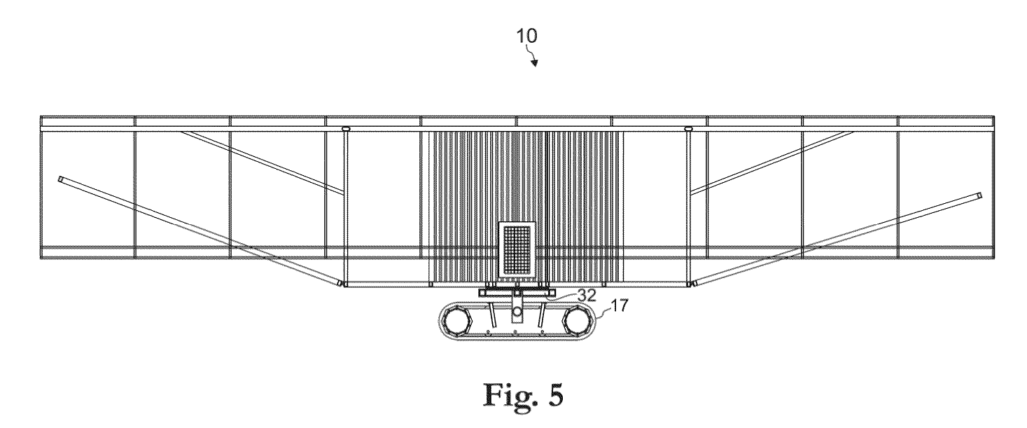

### DETAILED DESCRIPTION OF THE PREFERRED EMBODIMENTS

The major components of the harvesting apparatus 10 (“apparatus 10”) of the present invention include a working platform 12, a cooling zone 14, and a drive assembly 16 adapted to propel the apparatus 10. Embodiments of each of these major components will now be described, in greater detail.

Referring first to the working platform 12, it provides an elevated working surface that is capable of supporting the weight of workers 15 who may be standing thereon, and who may be engaged in one or more of a variety of tasks relating to operation of the apparatus 10 as herein described. In one embodiment, the working platform 12 includes sufficient surface space thereon to store empty clambshell packages (not shown), empty cartons 18 and empty pallets 20. The working platform 12 may further include package stations 22 to be utilized by pickers 24 who are walking in the field 26 proximate the working platform 12. The package stations 22 may be adopted to alternately fold out from the working platform 12 so as to be more conveniently located for the use of the pickers 24 or to fold inward so as to be stowed for transport of the apparatus 10. It may be desired to provide sides to the working platform 12, so as to permit safe use of the apparatus 10 on hillsides.

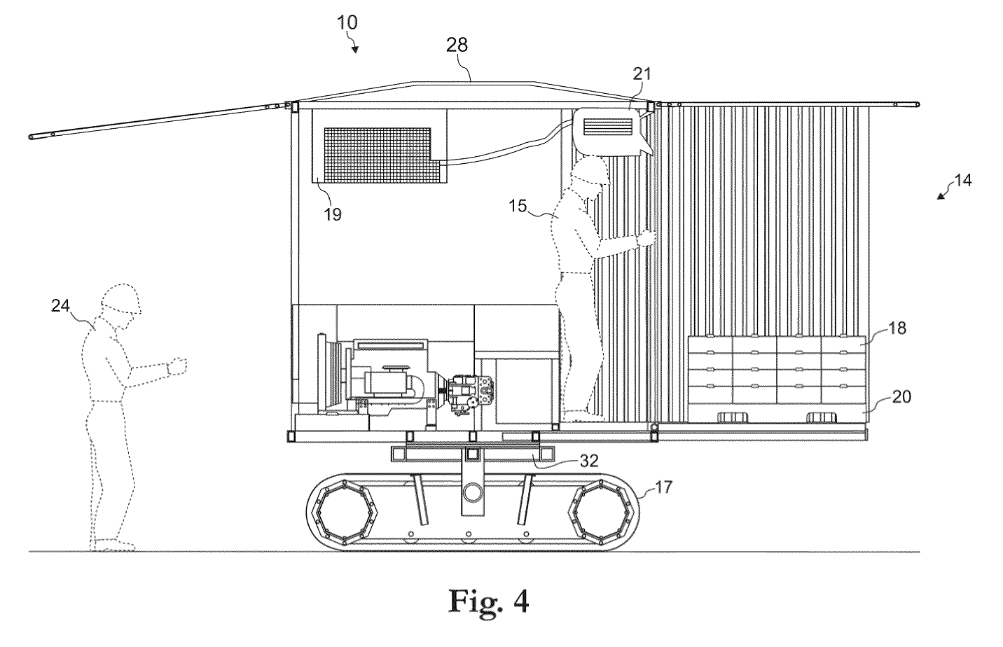

Optionally, a canopy 28 may be provided at an upper portion of the working platform 12, to shield workers 15 from the sun while engaged in activities on the working platform 12. The canopy 28 may be enlarged to also provide protection from pickers 24 working at package stations 22. See, e.g., FIG. 4. The canopy 28 may be configured to be capable of being retracted for transport or storage of the apparatus 10, for example by folding up, rolling up, or otherwise.

The cooling zone 14 comprises a refrigerated enclosure located on the working platform 12. In one embodiment, as shown by way of example in FIG. 4, cooling is provided by an air conditioning compressor unit 19 coupled to a blower unit 21, which blows refrigerated air into the cooling zone 14. The purpose of the cooling zone 14 is to promptly remove field heat from harvested produce, and to thereby increase shelf life. It is intended to be used to store loaded containers having therein produce picked by the pickers 24. The types of produce can include, for example, broccoli, cauliflower, lettuce, cantaloupe, melon (including watermelon). In one embodiment, the produce is berries, such as strawberries.

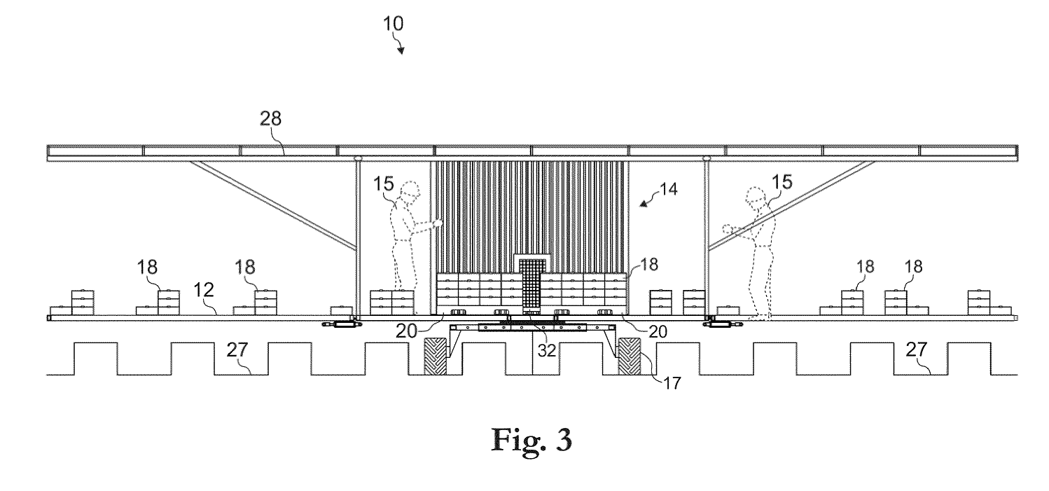

In one embodiment, which may be of particular benefit with the harvesting of strawberries, the containers are cartons 18, which may be directly loaded with harvested produce or which may contain a plurality of smaller containers known as clambshells. In one embodiment, the size of the cooling zone 14 is sufficient to be able to receive therein pallets 20, so that pallets 20 may be stored in the cooling zone 14 while loaded with filled cartons 18. Such a configuration would permit the ready off-loading, from an open, outwardly facing area of the cooling zone 14 of the apparatus 10, of packaged and palletized produce, for transport away from the field 26. As best seen in FIG. 3, in one embodiment, the cooling zone is configured to permit the placement of two pallets 20 side-by-side, so as to permit more rapid and efficient off-loading of filled pallets 20 from the apparatus 10.

In one embodiment of a method consistent with the present invention, it may be desired to apply a bar code or similar identification device (e.g., an RFID tag) on individual packages (e.g., clambshells) or large packages (e.g., cartons 18) containing therein a plurality of smaller packages. Such a device may be applied, for example, by pickers 24 or workers 15. Further, in one embodiment, it may be desired to promptly download bar code or like information into a database, together with global positioning information identifying a location where packaged produce was harvested. Such action can contribute to enhanced quality control, efficiency, safety, and can provide other benefits.

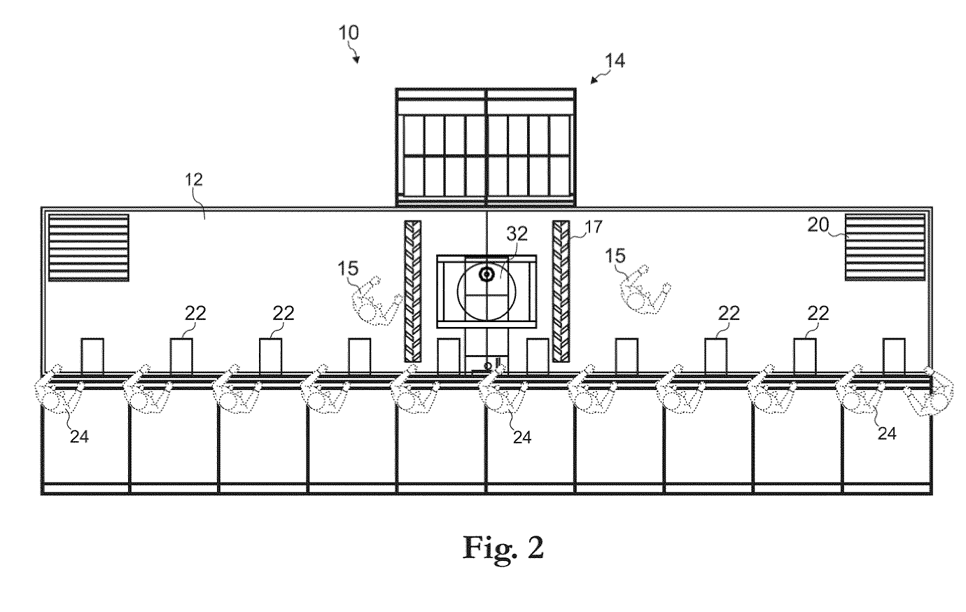

As best seen in the embodiment of FIG. 2, the cooling zone 14 may be located along an opposite side of the working platform 12 from that which contains the package stations 22. This configuration would permit a second vehicle (not shown), such as a tractor with a front end fork lift assembly, to approach the apparatus 10 for off-loading purposes, without interfering with the activity of the pickers 24. In one method, the vehicle may approach the apparatus 10 for offloading while the apparatus 10 is located in the field and while harvesting operations are ongoing.

From the unloading vehicle, the harvested and packaged produce may be transferred a second time, for example to a field truck. In one embodiment, the field truck is refrigerated, so as to preserve the cooling benefit provided by use of the cooling zone 14.

The portion of the cooling zone 14 extending outward from the working platform 12 may be supported by pull-out arms 30, which may be removed for transport or storage of the apparatus 10. When the outward extending portion of the cooling zone 14 is removed, the width of the working platform 12 is preferably within a range—e.g., no more than 102″—that would permit the legal transport of the apparatus 10 on a highway.

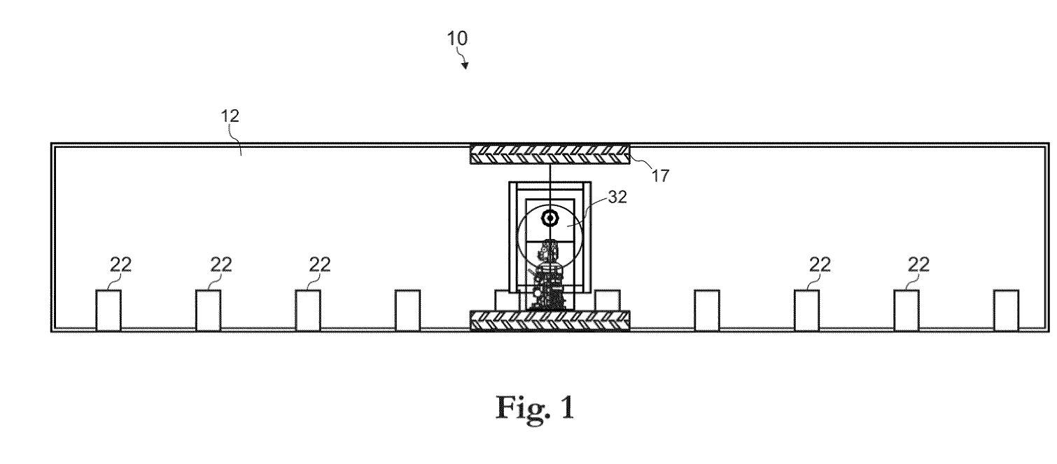

Referring now to the drive assembly 16, in one embodiment, it comprises a track assembly 17, so as to provide greater stability of the apparatus 10 during operation, an enhanced ability to operate on hillsides, and reduced machine compaction. The track assembly 17 may be coupled to an underside of the working platform 12 with a turntable assembly 32, so that the track assembly 17 may be rotated 90 degrees in relation to the working platform 12. This would permit the track assembly 17 to be placed in a first configuration, at a right angle to orientation of the working platform 12 (see, e.g., FIGS. 2-3), so that individual tracks of the track assembly 17 may travel in furrows 27 during harvesting operation. At an end of furrows 27, the track assembly 17 may be turned 90 degrees utilizing turntable assembly 32 (see, e.g., FIG. 1), to more readily permit movement of the entire apparatus 10 to the next harvest location. (Such configuration could also be used to facilitate loading of the apparatus 10 onto a trailer for transport. See, e.g., FIG. 4.)

Operation of the apparatus 10 may be controlled from a stationary control station on the apparatus 10 or, optionally, remotely utilizing a radio-controlled, remote system. It may be desired to provide a self-guiding control arm to improve its ability to maintain travel on a center line in the furrows.

While the invention has been particularly shown and described with reference to preferred embodiments thereof, it will be understood by those skilled in the art that the foregoing and other changes in form and details may be made therein without departing from the spirit and scope of the invention.

We claim:

1. A mobile cooling apparatus for harvested produce comprising, in combination:
a working platform;
a cooling zone accessible from the working platform and positioned to receive therein produce picked by pickers working in a field along the apparatus; and
a drive assembly adapted to propel the working platform and cooling zone through a field.

2. The apparatus of claim 1 further comprising package stations located on the working platform.

3. The apparatus of claim 2 wherein the package stations alternately fold out from the working platform so as to be more conveniently located for the use of the pickers and fold inward so as to be stowed for transport.

4. The apparatus of claim 1 further comprising a canopy located at an upper portion of the working platform and positioned so as to shield at least one worker on the working platform from the sun.

5. The apparatus of claim 1 wherein the canopy extends sufficiently beyond the working platform so as to additionally shield at least one picker.

6. The apparatus of claim 4 wherein the canopy is retractable.

7. The apparatus of claim 1 wherein the working platform has a first side accessible to the pickers working in the field along the apparatus and a second side opposite thereto and wherein the cooling zone is located proximate the second side.

8. The apparatus of claim 7 wherein the cooling zone is open at an end facing outward from the apparatus, and wherein such opening is dimensioned to permit off-loading of harvested produce from an interior of the cooling zone to another mobile apparatus.

9. The apparatus of claim 1 wherein cooling of the cooling zone is provided by an air conditioning compressor unit coupled to a blower unit located within the cooling zone.

10. The apparatus of claim 7 wherein the cooling zone is removably coupled to the working platform and capable of being removed therefrom to reduce a width of the apparatus.

11. The apparatus of claim 8 wherein the cooling zone is sufficiently wide to permit the loading therein, and off-loading therefrom, of pallets.

12. The apparatus of claim 11 wherein the cooling zone is sufficiently wide to permit the loading therein, and off-loading therefrom, of two pallets positioned side-by-side.

13. A mobile cooling apparatus for harvested produce comprising, in combination:
a working platform;
a cooling zone removably coupled to the working platform and positioned to receive therein produce picked by pickers working in a field along the apparatus; and
a drive assembly adapted to propel the working platform and cooling zone through a field;
wherein the working platform has a first side accessible to the pickers working in the field along the apparatus and a second side opposite thereto and wherein the cooling zone is located proximate the second side; and
wherein the cooling zone is open at an end facing outward from the apparatus, and wherein such opening is dimensioned to permit off-loading of harvested produce from an interior of the cooling zone to another mobile apparatus.

14. A method for mobile cooling of harvested produce comprising:
providing a mobile cooling apparatus comprising, in combination:
a working platform;
a cooling zone accessible from the working platform and positioned to receive therein produce picked by pickers working in a field along the apparatus; and
a drive assembly adapted to propel the working platform and cooling zone through a field;
receiving newly-harvested produce on the working platform; and
placing the newly-harvested produce into the cooling zone.

15. The method of claim 14 wherein the working platform has a first side accessible to the pickers working in the field along the apparatus and a second side opposite thereto and wherein the cooling zone is located proximate the second side and wherein the cooling zone is open at an end facing outward from the apparatus and further comprising bringing a second mobile apparatus into sufficient proximity of the open end to permit off-loading of harvested produce from an interior of the cooling zone to the second mobile apparatus.

16. The method of claim 15 further comprising off-loading the harvested produce from the second mobile apparatus to a third mobile apparatus and wherein the third mobile apparatus is refrigerated.

17. The method of claim 14 further comprising applying, on the working platform, identification information to a package containing the produce.

18. The method of claim 17 wherein the identification information includes global positioning data.

19. The method of claim 14 wherein the produce is strawberries.

20. The method of claim 14 wherein movement of the apparatus is controlled remotely.
